(19) United States
(12) Patent Application Publication
(10) Pub. No.: US 2026/0008464 A1
(43) Pub. Date: Jan. 8, 2026

(54) METHOD OF STARTING A MOTOR VEHICLE

(71) Applicant: ZF Friedrichshafen AG, Friedrichshafen (DE)

(72) Inventors: Christian Netzer, Markdorf (DE); Ulf Lang, Friedrichshafen (DE); Jürgen Blaser, Meckenbeuren (DE); Peter Herter, Ravensburg (DE)

(73) Assignee: ZF Friedrichshafen AG, Friedrichshafen (DE)

(21) Appl. No.: 19/261,173

(22) Filed: Jul. 7, 2025

(30) Foreign Application Priority Data
Jul. 8, 2024 (DE) 10 2024 206 398.3

(51) Int. Cl. B60W 30/18; B60W 10/02; B60W 10/06

(52) U.S. Cl. CPC B60W 30/18027; B60W 10/026; B60W 10/06; B60W 2540/10; B60W 2710/022; B60W 2710/025; B60W 2710/0666

(57) ABSTRACT

A method of starting a motor vehicle is initiated as soon as a requested torque is preset on the driver's side when the vehicle is at a standstill. During starting, a starting element in the drive train is closed, establishing a drive connection between an internal combustion engine connected to a drive side of the starting element and an output of the drive train connected to an output side of the starting element, thereby adjusting an output speed at the output side to an input speed at the drive side of the starting element. While closing the starting element, a torque gradient used to adjust a target torque is changed to a closing gradient until a lower limit value is undershot by a difference between the input speed and the output speed. The closing gradient is set below a preset gradient defined based on the preset requested torque.

### RELATED APPLICATIONS

This application claims the benefit of and right of priority under 35 U.S.C. § 119 to German Patent Application no. 10 2024 206 398.3, filed on 8 Jul. 2024, the contents of which are incorporated herein by reference in its entirety.

### FIELD OF THE DISCLOSURE

The invention relates to a method for performing a starting operation in a motor vehicle, wherein the starting operation is initiated as soon as a requested torque is preset on the driver's side when the motor vehicle is at a standstill, wherein, during the starting operation, a starting element in a drivetrain of the motor vehicle is closed in a closing operation, in the course of which a drive connection is established via the starting element between an internal combustion engine of the drivetrain connected to a drive side of the starting element and an output of the drivetrain connected to an output side of the starting element, thereby adjusting an output speed prevailing on the output side of the starting element to an input speed prevailing on the drive side of the starting element. Furthermore, the invention relates to a control device, a computer program product, and a data carrier.

### BACKGROUND

In drivetrains of motor vehicles equipped with internal combustion engines, starting elements are typically used to separate the internal combustion engine from the drive wheels of the motor vehicle when the vehicle is at a standstill, as well as to enable the motor vehicle to start from a standstill. The respective starting element is provided in the respective drivetrain between the respective internal combustion engine and the drive wheels of the motor vehicle. In most cases, a starting element is located in a drivetrain as a disconnecting clutch or as a hydrodynamic torque converter. During a starting operation, a drive connection is established between the internal combustion engine and the drive wheels of the respective motor vehicle via the respective starting element in order to enable torque to be transmitted from the internal combustion engine to the drive wheels.

DE 10 2019 206 152 A1 describes a method for performing a start-up operation in a motor vehicle, wherein the starting operation is triggered on the driver's side by pressing the accelerator pedal. In the following, a requested torque is determined on the basis of the operation on the driver's side and a starting element designed as a disconnecting clutch is closed, which results in the establishment of a drive connection between an internal combustion engine and an output of the motor vehicle in a drivetrain of the motor vehicle. During closing, the speeds at the starting element are adjusted to each other so that, when the disconnecting clutch is completely closed, the drive side of the starting element connected to the internal combustion engine has essentially the same speed as the output side of the starting element connected to the output

### SUMMARY

Based on the state of the art described above, the present invention aims to provide a reliable starting operation for motor vehicles

From a point of view of the method, this task is solved by methods, a control device, and a computer program product as disclosed herein. Further advantageous developments will be apparent from the present disclosure.

According to the invention, in a method for performing a starting operation in a motor vehicle, the starting operation is initiated as soon as a requested torque is preset on the driver's side when the motor vehicle is at a standstill. During the starting operation, a starting element in a drivetrain of the motor vehicle is closed in a closing operation, in the course of which a drive connection is established via the starting element between an internal combustion engine of the drivetrain connected to a drive side of the starting element and an output of the drivetrain connected to an output side of the starting element, thereby adjusting an output speed prevailing on the output side of the starting element to an input speed prevailing on the drive side of the starting element.

The method according to the invention is therefore used in a motor vehicle in which an internal combustion engine can be connected to an output via a starting element in the drivetrain in order to transmit drive torque to the output. The motor vehicle is preferably a commercial vehicle, such as a truck or bus. The drivetrain output comprises in particular at least one drive wheel of the motor vehicle, preferably drive wheels of at least one drive axle. The starting element is arranged in the power flow between the internal combustion engine and the output, wherein the starting element is connected to the internal combustion engine on the drive side and to the output on the output side. In particular, a motor vehicle gearbox, which is preferably designed as a transmission gearbox, for example, in the form of an automatic gearbox or an automated manual gearbox, and a differential gearbox assigned to at least one drive axle are arranged between the output side of the starting element and the output.

In the method according to the invention, the starting operation is then initiated when a requested torque is preset on the driver's side while the motor vehicle is at a standstill. As soon as a driver of the motor vehicle performs an action that defines a requested torque for starting the motor vehicle, the starting operation is initiated. Preferably, the requested torque is preset on the driver's side by using an accelerator pedal.

When the starting operation is performed, the starting element located between the internal combustion engine and the output in the power flow is closed, wherein this closing takes place as part of a closing operation. When closed, torque is transmitted from the drive side to the output side at the starting element, thereby also establishing the drive connection between the internal combustion engine and the output by transmitting torque. Preferably, the starting element is initially operated in slip mode at the start of the closing operation, in which torque transmission between the drive side and the output side already begins, but speed differences between the drive side and the output side still exist. During the closing operation, the speed difference between the input speed and the output speed is gradually reduced by gradually adjusting the output speed to match the input speed. With essentially complete agreement between the input speed and the output speed, the starting element is then completely closed and transmits the torque generated on the drive side to the output side, at least to the greatest possible extent. Before the starting operation begins, the starting element must be completely open, which, in the sense of the invention, means that independent rotation of the drive side relative to the output side is possible.

The invention now comprises the technical teaching that, during the closing operation of the starting element, a torque gradient, with the aid of which a target torque of the internal combustion engine is adjusted, is changed to a closing gradient until a lower limit value is undershot by a speed difference between the input speed and the output speed. The closing gradient is set lower than the preset gradient that would actually be defined based on the preset requested torque.

In other words, during the closing operation of the starting element, the system checks whether the speed difference between the input speed and the output speed falls below a lower limit value. Until the lower limit value is undershot, a torque gradient, which describes the course of a target torque of the internal combustion engine, is designed in accordance with a closing gradient. This closing gradient is lower than a preset gradient, which is actually preset by the requested torque on the driver's side.

This type of starting operation has the advantage that excessive torque on the drive side is prevented during the closing operation of the starting element, thereby ensuring that the closing operation is performed reliably. Otherwise, the torque gradient may be adjusted in accordance with the preset gradient defined by the requested torque, resulting in a high torque to be transmitted between the drive side and the output side by the starting element, which hinders or even prevents the starting element from closing. Due to the fact that, during the closing operation, the torque gradient is forcibly changed from the preset gradient to the lower closing gradient until the speed difference falls below the lower limit value, the invention enables the starting element to be closed sufficiently wide.

By changing the torque gradient to the lower closing gradient, a flatter increase in the target torque of the internal combustion engine is preset compared to the preset gradient, so that the starting element also has to transmit a lower torque in slip when closing and reducing the speed difference. This results in lower stress on the starting element and, in particular, lower heat input into the starting element. Overall, this allows the starting operation to be carried out reliably, even when the starting element is combined with an internal combustion engine that is actually too powerful for the starting element.

In particular, the lower limit value with the aid of which the speed difference is compared is preset, wherein this presetting is preferably made depending on the characteristic data of the starting element. The preset gradient is defined by the requested torque preset on the driver's side and therefore depends primarily on how hard the driver presses the accelerator pedal. For example, pressing the accelerator pedal firmly results in a steeper preset gradient while pressing it gently results in a flatter preset gradient.

According to one embodiment of the invention, the closing gradient is selected to be zero so that a constant target torque is adjusted when the torque gradient on the closing gradient is changed by the internal combustion engine. This has the advantage that the load on the starting element during closing and the associated adjustment of the output speed to the input speed can be kept very low.

Alternatively, the closing gradient can be designed with a flatter positive curve than the preset gradient, depending on the preset gradient. This means that an increase in the target torque is selected to be flatter compared to the preset gradient preset on the driver's side, thereby also reducing the load on the starting element during the closing operation. In a further development of this variant of the invention, if the closing gradient is designed to depend on the preset gradient, the closing gradient is adjusted if the preset gradient changes during the closing operation of the starting element due to a change in the requested torque. This has the advantage that the driver is given feedback on any change to his presetting, as a change to the requested torque also results in a change to the closing gradient For the driver, a change in the operation of the accelerator pedal is therefore particularly noticeable in a change in the torque gradient, wherein the closing gradient defining the torque gradient remains lower than the preset gradient of the changed requested torque.

According to an advantageous embodiment of the invention, the speed difference is compared with an upper limit value when the requested torque is preset and before the closing operation is started, wherein, if the speed difference exceeds the upper limit value, the torque gradient is changed to a negative pre-closing gradient deviating from the preset gradient. This has the advantage that the closing of the starting element can be designed to represent the starting operation in a reliable manner even if a high target torque of the internal combustion engine is already preset at the start of the starting operation and the input speed of the starting element is therefore already so high that closing the starting element is difficult or even impossible. This is because changing the torque gradient to the negative pre-closing gradient results in a reduction in the target torque and thus also a reduction in the input speed. Preferably, the upper limit corresponds to a speed difference limit above which closing the starting element is difficult or no longer possible.

Another embodiment of the invention is that the torque gradient is changed from below the lower limit value to a positive starting gradient that is higher than the preset gradient until a target value is reached by the actual torque of the internal combustion engine. This has the advantage that, as soon as the lower limit value is undershot and thus a low speed difference defined by this is reached, a torque gradient that is steeper than the preset gradient is achieved by changing the torque gradient to the starting gradient, which is steeper than the preset gradient. This allows the remaining starting operation to be shortened from the point at which this change to the starting gradient occurs. This is repeated until the actual torque of the internal combustion engine reaches the target value. Alternatively, the torque gradient could also be changed back to the preset gradient when it falls below the lower limit value. In particular, the target value is defined by the requested torque, although alternatively, the target value could also be defined by a torque limitation for the internal combustion engine.

The starting element is preferably a hydrodynamic torque converter. During the closing operation, a bypass clutch of the torque converter is then closed, with the bypass clutch preferably being closed in stages.

Another object of the invention is a control device which is designed to control a starting operation of the motor vehicle when a requested torque is present on the driver's side when a motor vehicle is at a standstill and to cause a starting element in a drivetrain of the motor vehicle to close in a closing operation in the course of the starting operation, in the course of which the starting element drives an internal combustion engine of the drivetrain connected to a drive side of the starting element to an output of the drivetrain connected to an output side of the starting element and thereby adjusts an output speed prevailing on the output side of the starting element to an input speed prevailing on the drive side of the starting element. Furthermore, the control device is designed to change a torque gradient, with the aid of which a target torque of the internal combustion engine is adjusted, to a closing gradient during the closing operation of the starting element until a speed difference between the input speed and the output speed falls below a lower limit value. The closing gradient is lower than the preset gradient that would actually be defined based on the preset requested torque.

The method according to the invention can also be embodied as a computer program product which, when running on a processor, for example a processor of a aforementioned control device, instructs the processor by means of software to carry out the associated method steps according to the invention. In this context, the invention also includes a computer-readable medium on which a computer program product as described above is stored in a retrievable form.

### BRIEF DESCRIPTION OF THE DRAWINGS

Advantageous embodiments of the invention, which is discussed in the following, are shown in the drawings. The figures show:

FIG. 1 a schematic representation of a motor vehicle; and

FIG. 2 a flow chart of a method according to the invention for performing a starting operation in the motor vehicle shown in FIG. 1.

### DETAILED DESCRIPTION

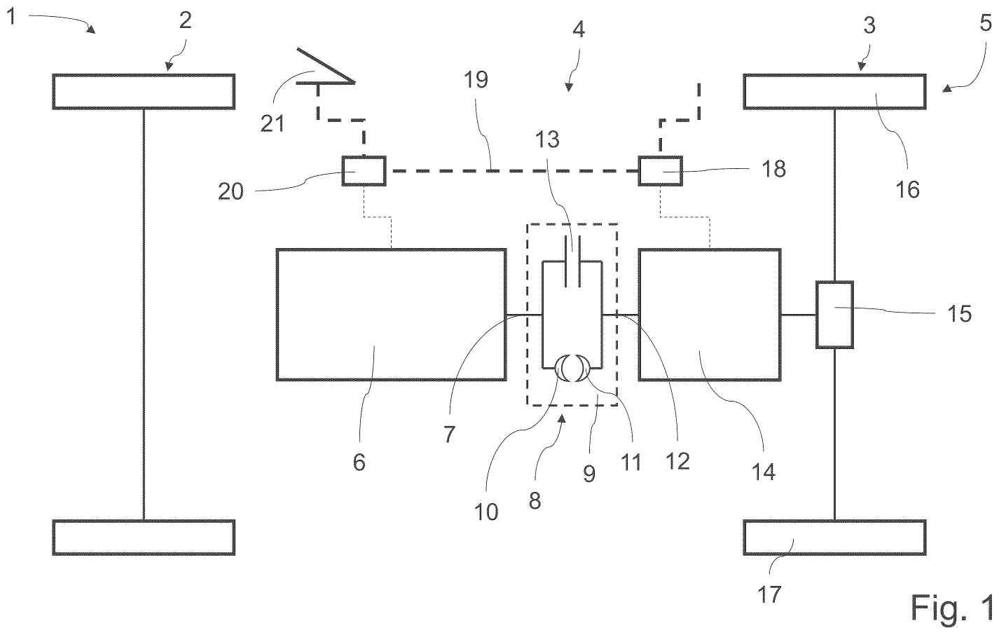

FIG. 1 shows a schematic view of a motor vehicle 1, which is in particular a commercial vehicle, for example a truck or a bus. In addition to a non-drive vehicle axle 2, the motor vehicle 1 comprises a drive axle 3, which is part of a drivetrain 4 of the motor vehicle 1 and forms an output 5 of the drivetrain 4. In a manner known to those skilled in the art, motor vehicle 1 could have additional drive axles in addition to drive axle 3.

The drivetrain 4 comprises an internal combustion engine 6, which is connected on the output side to a drive side 7 of a downstream starting element 8. The starting element 8 is a hydrodynamic torque converter 9, which is equipped with a pump impeller 10, a turbine impeller 11, and a guide impeller (not shown here). While the pump impeller 10 is connected in a rotationally fixed manner to the drive side 7 and is therefore permanently connected to the upstream internal combustion engine 6, the turbine impeller 11 is connected in a rotationally fixed manner to an output side 12 of the hydrodynamic torque converter 9. In addition, the hydrodynamic torque converter 9 also has a bypass clutch 13, which is preferably designed as a friction clutch.

On the output side 12 of the hydrodynamic torque converter 9, a connection is established to a gearbox input of a downstream motor vehicle gearbox 14, which is designed in particular as an automatic gearbox. In the motor vehicle gearbox 14, different gears can be selected, in each of which the drive movement initiated at the gearbox input is transmitted to a gearbox output of the motor vehicle gearbox 14. At the gearbox output, the motor vehicle gearbox 14 is connected to a downstream differential gearbox 15, which, as a transverse differential, distributes an input drive torque to drive wheels 16 and 17 of the drive axle 3. In the case of multiple drive axles, the differential gearbox 15 would then distribute power to the multiple drive axles in a manner known to those skilled in the art as a longitudinal differential.

Closing the hydrodynamic torque converter 9 establishes a drive connection between the internal combustion engine 6 and the motor vehicle gearbox 14, which initially takes place during a closing operation of the torque converter 9 by hydraulically coupling the pump impeller 10 and the turbine impeller 11 to each other in a manner known to those skilled in the art via fluid located in the hydrodynamic torque converter 9. This allows torque to be transmitted from the internal combustion engine 6 to the gearbox input of the motor vehicle gearbox 14, wherein the guide impeller causes an increase in torque. During the closing operation of the hydrodynamic torque converter 9, an output speed of the output side 12 is increasingly adjusted to an input speed of the drive side 7, wherein, once this adjustment has reached a certain level, the bypass clutch 13 is closed in stages, thereby establishing a mechanical connection between the drive side 7 and the output side 12.

The hydrodynamic torque converter 9 is controlled in this case by a control device 18, which also controls the motor vehicle gearbox 14 as a gearbox control device. In the present case, the control device 18 is connected to a data bus system 19 with an engine control device 20 for data exchange, via which the operation of the internal combustion engine 6 is controlled. Within the data bus system 19, the control device 18 and also the engine control device 20 are additionally supplied with various information, including the position of an accelerator pedal 21 of the motor vehicle 1.

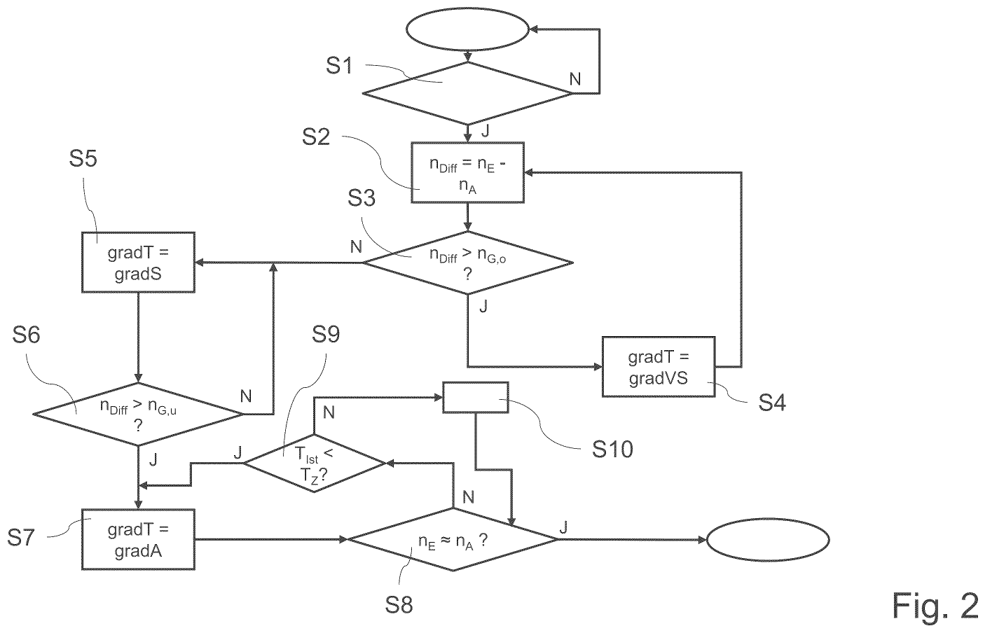

A starting operation for motor vehicle 1 can be carried out within the scope of a method according to the invention, the flow chart of which is shown in FIG. 2 and which will now be described in more detail with reference to this flow chart:

The method according to the invention is initiated as soon as the motor vehicle 1 is at a standstill, wherein the method is carried out by the control device 18. In a first step S1, a query is made as to whether a starting operation is being initiated by a driver of motor vehicle 1, for which purpose the position of the accelerator pedal 21 is checked. If the accelerator pedal 21 is not pressed and therefore no starting operation is required, the system returns to step S1 and performs another check.

If, on the other hand, actuation of the accelerator pedal 21 is detected, this is evaluated as a request from the driver to initiate the starting operation of the motor vehicle 1 and the system then proceeds to step S2. In this step S2, a current input speed n_{I} of the drive side 7 of the hydrodynamic torque converter 9 and a current output speed n_{O} of the driven side 12 of the hydrodynamic torque converter 9 are queried and a speed difference now is defined from these.

This speed difference noir is compared with an upper limit value n_{L, u} in a further step S3, wherein if the upper limit value n_{L, u} is exceeded, the process proceeds to step S4, otherwise it proceeds to step S5. If the upper limit value n_{L, u} is exceeded by the speed difference n_{Diff}, this indicates that the input speed n_{I} on the drive side 7 has already increased significantly due to the requested torque preset on the driver's side on the accelerator pedal 21, which makes it difficult or even impossible for the hydrodynamic torque converter 9 to close. For this reason, the control device 18 then causes, in step S4, via the engine control device 20, a change in a torque gradient gradT, with the aid of which a target torque is adjusted at the internal combustion engine 6. In doing so, the torque gradient gradT in step S4 is changed to a negative pre-closing gradient gradPC deviating from the vehicle driver's presetting at the accelerator pedal 21, whereby the target torque of the internal combustion engine 6 is reduced with a low, negative increase. The process then returns to step S2, where the speed difference n_{Diff} is determined again and compared with the upper limit value n_{L, u} in step S3.

If, on the other hand, the speed difference n_{Diff} does not (or no longer) exceed the upper limit n_{L, u}, the closing operation of the hydrodynamic torque converter 9 is initiated in step S5 and, with this initiation, the torque gradient gradT is changed to a closing gradient gradC. In a first variant of the method according to the invention, the closing gradient gradC can be zero, whereupon the internal combustion engine 6 maintains the target torque adjusted at the start of the closing operation at the current level. According to an alternative second variant of the method according to the invention, the closing gradient gradC can also be designed to depend on a preset gradient, which is defined by the requested torque preset by the driver on the accelerator pedal 21. In this case, however, the closing gradient gradC defines a flatter increase in the target torque of the internal combustion engine 6 compared to the preset gradient.

Following step S5, the speed difference n_{Diff} is then determined again in step S6 and now compared with a lower limit value n_{L, l}. If the speed difference now falls below the lower limit value n_{L, l}, the program proceeds to step S7; otherwise, it returns to step S5 and the change in the torque gradient gradT in step SS is retained. If there has been a change in the operation of the accelerator pedal 21 in the meantime, the closing gradient gradC is also changed in the second variant of the method according to the invention due to the resulting change in the requested torque and, consequently, also in the preset gradient.

However, when transitioning to step S7, the torque gradient gradT is changed via the control device 18 to a starting gradient gradS, which has a steeper positive curve compared to the preset gradient preset on the driver's side. In this respect, the change in step S7 leads to a steeper increase in the target torque of the internal combustion engine 6 compared to the presetting on the driver's side. Following step S7, step S8 then checks whether the input speed n_{I} already essentially corresponds to the output speed n_{O}. If this is the case, the method according to the invention is terminated, otherwise the method proceeds to step S9.

In step S9, an actual torque T_{Actual} of the internal combustion engine 6 is queried and compared with a target value T_{T}. This target value T_{T} can correspond either to the preset requested torque or to a torque limitation of the internal combustion engine 6. If the actual torque T_{Actual} below the target value T_{T}, the system returns to step S7, whereas step S10 is initiated when the target value T_{T} is reached. In step S10, the preset requested torque or a torque defined by the torque limitation is then maintained and, in step S8, the input speed n_{I} is again adjusted to the output speed n_{O}.

By means of the implementation according to the invention, a starting operation in a motor vehicle can be designed in a reliable manner.

### LIST OF REFERENCE NUMERALS

1 motor vehicle
2 vehicle axle
3 drive axle
4 drivetrain
5 output
6 internal combustion engine
7 drive side
8 starting element
9 hydrodynamic torque converter
10 pump impeller
11 turbine impeller
12 output side
13 bypass clutch
14 motor vehicle gearbox
15 differential gearbox
16 drive wheel
17 drive wheel
18 control device
19 data bus system
20 engine control device
21 accelerator pedal
n_{I} input speed
n_{O} output speed
n_{Diff} speed difference
n_{L, u} upper limit value
n_{L, l} lower limit value
gradT torque gradient
gradPC pre-closing gradient
gradS closing gradient
gradS starting gradient
T_{Actual} actual torque
T_{T} target value
S1 through S10 individual steps

1. A method of starting a motor vehicle (1), comprising:
initiating a starting operation as soon as a requested torque is preset on the driver's side when the motor vehicle (1) is at a standstill;
closing a starting element (8) in a closing operation in a drive train (4) of the motor vehicle (1) in the course of the starting operation, in the course of which:
establishing a drive connection via the starting element (8) between an internal combustion engine (6) of the drive train (4), which is connected to a drive side (7) of the starting element (8), and an output (5) of the drive train (4), which is connected to an output side (12) of the starting element (8); and
adjusting an output speed (n_{O}) prevailing at the output side (12) of the starting element (8) to an input speed (n_{I}) prevailing on the drive side (7) of the starting element (8); and
changing a torque gradient (gradT), with the aid of which a target torque of the internal combustion engine (6) is adjusted, to a closing gradient (gradC) until a lower limit value (n_{L, l}) is undershot by a speed difference (n_{Diff}) between the input speed (n_{I}) and the output speed (n_{O});
wherein the closing gradient (gradC) is configured to be lower than a preset gradient actually defined on the basis of the preset requested torque.

2. The method according to claim 1, comprising selecting the closing gradient (gradC) to be zero or to have a flatter positive curve than the preset gradient, depending on the preset gradient.

3. The method according to claim 2, wherein the closing gradient (gradC) depends on the preset gradient, the method further comprising:
determining that the preset gradient changes during the closing operation of the starting element (8) due to a change in the requested torque; and
adjusting the closing gradient (gradC).

4. The method according to claim 3, comprising:
with the requested torque being preset and before the closing operation is started, comparing the speed difference (n_{Diff}) with an upper limit value (n_{L, u});
determining that the speed difference (n_{Diff}) exceeds the upper limit value (n_{L, u}); and
changing the torque gradient (gradT) to a negative pre-closing gradient (gradPC) deviating from the preset gradient.

5. The method according to claim 4, comprising changing the torque gradient (gradT) from below the lower limit value (n_{L, l}) to a positive starting gradient (gradS) which is higher than the preset gradient until a target value (T_{T}) is reached by an actual torque (T_{Actual}) of the internal combustion engine (6).

6. Method The method according to claim S. characterized-in-that comprising defining the target value (Tr) is defined by the requested torque or a torque limitation of the internal combustion engine (6).

7. The method according to claim 1, comprising providing the starting element (8) as a hydrodynamic torque converter (9).

8. The method according to claim 7, comprising closing a bypass clutch (13) of the torque converter (9) during the closing operation

9. A control device (18) configured to control a starting operation of a motor vehicle (1) having an internal combustion engine, the control device configured to;
receive a requested torque on the driver's side when the motor vehicle is at a standstill;
close a starting element (8) in a drive train (4) of the motor vehicle (1) in a closing operation in the course of the starting operation, in the course of which the starting element (8) drives the internal combustion engine (6) of the drive train (4) connected to a drive side (7) of the starting element (8) with an output (5) of the drive train (4) connected to an output side (12) of the starting element (8), and thereby adjusting an output speed (no) prevailing on the output side (12) of the starting element (8) to match an input speed (n_{I}) prevailing on the drive side (7) of the starting element (8); and
change a torque gradient (gradT), with the aid of which an adjustment of a target torque of the internal combustion engine (6) takes place, to a closing gradient (gradC) during the closing operation of the starting element (8), until a speed difference (n_{Diff}); between the input speed (n_{I}) and the output speed (n_{O}) falls below a lower limit value (n_{L, l}));
wherein the closing gradient (gradC) is configured to be lower than a preset gradient actually defined on the basis of the preset requested torque.

10. The control device (18) according to claim 9, which is further configured to carry out the starting operation comprising:
initiating the starting operation in response to receiving the requested torque on the driver's side;
closing the starting element (8) in the closing operation in the drive train (4) of the motor vehicle (1) in the course of the starting operation, wherein closing the starting element comprises:
establishing a drive connection via the starting element (8) between an internal combustion engine (6) of the drive train (4) connected to the drive side (7) of the starting element (8), and to the output(S) of the drive train (4) connected to the output side (12) of the starting element (8); and
adjusting the output speed (no) prevailing at the output side (12) of the starting element (8) to match the input speed (m) prevailing on the drive side (7) of the starting element (8), and
selecting the closing gradient (gradC) to be zero or to have a flatter positive curve than the preset gradient, depending on a value of the preset gradient and
changing the torque gradient (gradT), with the aid of which the target torque of the internal combustion engine (6) is adjusted, to match the closing gradient (gradC) until the lower limit value (n_{L, l}) is undershot by the speed difference (n_{Diff}) between the input speed (n_{I}) and the output speed (n_{O});
wherein the closing gradient (gradC) is configured to be lower than the preset gradient actually defined on the basis of the preset requested torque

11. A computer program product having executable code that, when executed by a control device, executes the method according to claim 1, wherein a routine for performing the starting operation is implemented by corresponding control commands stored in software.

12. (canceled)
